(19) United States
(12) Patent Application Publication
(10) Pub. No.: US 2014/0195897 A1
(43) Pub. Date: Jul. 10, 2014

(54) Text Summarization

(71) Applicants: Helen Y. Balinsky, Cardiff (GB); Alexander Balinsky, Cardiff (GB); Steven J. Simske, Ft Collins, CO (US)

(72) Inventors: Helen Y. Balinsky, Cardiff (GB); Alexander Balinsky, Cardiff (GB); Steven J. Simske, Ft Collins, CO (US)

(21) Appl. No.: 14/235,876

(22) PCT Filed: Sep. 20, 2011
(86) PCT No.: PCT/US2011/052386

§ 371 Date: Jan. 29, 2014

(51) Int. Cl. G06F 17/21

(52) U.S. Cl. CPC G06F 17/212
USPC 715/254

(57) ABSTRACT

Methods, systems, and computer readable media with executable instructions, and/or logic are provided for text summarization. An example method of text summarization can include determining, via a computing system (674), a graph (314) with a small world structure, corresponding to a document (300) comprising text, wherein nodes (316) of the graph (314) correspond to text features (302, 304) of the document (300) and edges (318) between particular nodes (316) represent relationships between the text features (302, 304) represented by the particular nodes (316) (440). The nodes (316) (442) are ranked via the computing system (674), and those nodes (316) having importance in the small world structure (444) are identified via the computing system. Text features (302, 304) corresponding to the indentified nodes (316) are selected, via the computing system (674), as a summary (334) of the document (300) (446).

### BACKGROUND

With the number of electronically-accessible documents now greater than ever before in business, academic, and other settings, techniques, for accurately summarizing large bodies of documents are of increasing importance. Automated text summarization techniques may be used to perform a variety of document-related tasks. For example, in some applications, a business, academic organization, or other entity may desire to automatically classify documents, and/or create a searchable database of documents, such that a user may quickly access a desired document using search terms.

### BRIEF DESCRIPTION OF THE DRAWINGS

FIG. 1 illustrates a path graph according to various examples of the present disclosure.

FIG. 2 illustrates a graph based on a meaningfulness parameter according to various examples of the present disclosure.

FIG. 3 conceptually illustrates one example of a method for text summarization according to various examples of the present disclosure.

FIG. 4 illustrates an example method for text summarization according to various examples of the present disclosure.

FIG. 5 illustrates a plot of degree-rank function for different values of a meaningfulness parameter according to various examples of the present disclosure.

FIG. 6 illustrates a block diagram of an example computing system used to implement a method for text summarization according to the present disclosure.

FIG. 7 illustrates a block diagram of an example computer readable medium (CRM) in communication with processing resources according to the present disclosure.

### DETAILED DESCRIPTION

Examples of the present disclosure may include methods, systems, and computer readable media with executable instructions, and/or logic. According to various examples of the present disclosure, an example method of text summarization can include determining, via a computing system, a graph with a small world structure, corresponding to a document comprising text, wherein nodes of the graph correspond to text features of the document and edges between particular nodes represent relationships between the text features represented by the particular nodes. The nodes are ranked via the computing system, and those nodes having importance in the small world structure are identified via the computing system. Text features corresponding to the identified nodes are selected, via the computing system, as a summary of the document.

Previous approaches to automated natural language processing are often limited to empirical keyword analysis. Previous approaches to automated natural language processing typically have not utilized graph-based techniques, at least in part because of the difficulty of determining an appropriate graphing scheme. The present disclosure is directed to text summarization based on a graph-based text summarization.

Text summarization is an application of Natural Language Processing (NLP). Since manual summarization of large documents can be a difficult and time-consuming task, there is high demand for effective, fast, and reliable automatic text summarization methods and tools. Automatic text summarization is an interesting and challenging issue.

Automatic text summarization can be thought of as a type of information compression. To achieve such compression, better modeling and understanding of document structures and internal relationships between text features is helpful. A novel approach is presented herein to identify relevant text features from a document, which can be extracted and combined as a text summarization.

A summary can be defined as text that is produced torn original text, and that conveys relevant information regarding the original text in a more concise manner. Typically, a summary is no longer than half of the original text and is usually significantly less than that. Text as used herein, can refer to written characters, speech, multimedia documents, hypertext, etc.

Types of summarization can include abstractive summarization and extractive summarization. In abstractive summarization, main concepts and ideas of an original text can be represented by paraphrasing of the original text in clear natural language. In extractive summarization, the most meaningful parts of the original text (text features) are extracted from the original text in order to represent the main concepts and ideas of the original text.

While a document is built from words, the document is not simply a bag of words. The words are organized into various text features to convey the meaning of documents. Relationships between different text features, the position of respective text features, the order the text features appear in a document can all be relevant let document understanding.

Documents can be modeled by networks, with text features as the nodes. The edges between the nodes are used to represent the relationships between pairs of entities. Nearest text features in a document are often logically connected to create a flow of information. Therefore, an edge can be created between a pair of nearest text features. Such edges can be referred to as local or sequential network connections.

According to various examples of the present disclosure, a text document is modeled by one-parameter family graphs with text features (e.g., sentences, paragraphs, sections, pages, chapters, other language structures that include more than one sentence) as the set of graph nodes. Text features, as used herein, exclude language structures smaller than one sentence such as words alone, phrases (i.e., partial sentences). Edges are defined by the relationships between the text features. Such relationships can be determined based on keywords and associated characteristics such as occurrence, proximity, and other attributes discussed later. Keywords can be a carefully selected family of “meaningful” words. For example, a family of meaningful words cam be selected using the Helmholtz principle, with edges being defined therefrom. Meaningfulness can be determined relative to a meaningfulness parameter that can be used as a threshold for determining words, and/or relationships based on the keywords, as being meaningful.

Relevant text features can be determined by representing text as a network with a small world structure. More specifically, text can be modeled as a one-parameter family of graphs with text features defining the vertex set (e.g., nodes) and with edges defined by, for example, a carefully selected (e.g., using the Helmholtz principle) family of keywords. For some range of the parameter, the resulting network becomes a small-world structure. In this manner, many measures and tools from social network theory can be applied to the challenge of identifying and/or extracting the most relevant text features from a document.

To extract the most relevant text features from a document, a ranking function can be used to identify text features in an order of relevancy. One approach to define a ranking function uses a graph theoretic approach. Documents can be modeled by a network with nodes representing the text features of the document. The edges between the nodes can represent the relationships between pairs of nodes, including physical relationships such as proximity, and/or informational relationships, such as including at least one keyword.

From the network representation, a ranking function can be defined as a measure by which to determine relevant nodes in the network, and correspondingly, relevant text features of a document. According to some example examples of the present disclosure, ranking functions with a large range of values, with a small number of top values, and a long tail of small values (e.g., power-law distributions) can be utilized.

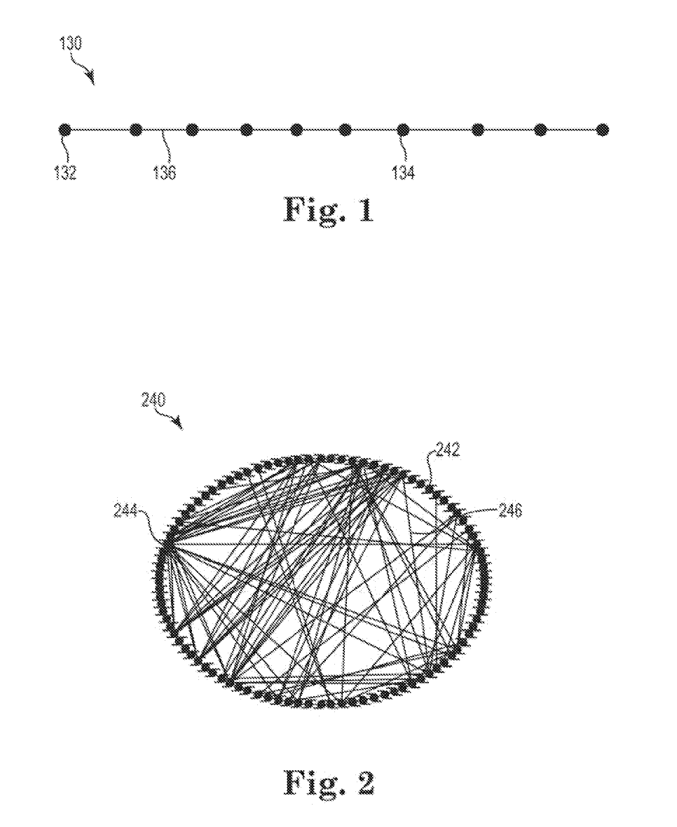

FIG. 1 illustrates a path graph that may be formed based on one value of a meaningfulness parameter according to various examples of the present disclosure. In a simple form, a network of relationships between nodes (e.g., 132, 134) representing text features is a linear path graph 130 representing each text feature being connected to those text features by an edge 136 created between a pair of nearest text features. That is, in a document text features can be arranged one after another, and are at least related by their relative locations to one another. This arrangement relationship can be represented by the path graph 130 shown in FIG. 1 illustrating a first text feature being related to a second paragraph by proximity in the document thereto.

However, a document can have a more complicated structure. Different parts of a document, either proximate or distant, can be logically connected. Therefore, text features should be connected if they have something relevant in common and are referring to something similar. For example, an author can recall or reference words in one location that also appear in another location. Such references can create distant relations inside the document. Due to these types of logical relationships that exist in the document, the relationships between text features can be reflected in the modeling technique of the present disclosure. Edges can be established between nodes representing non-adjacent text, features based on keyword, logical, or other relationship between the text features. A meaningfulness parameter can be used as a threshold with respect to the characteristic(s) “strength” of a relationship for establishing an edge between particular nodes on the graph.

For example, a set of keywords of a document can be identified. The size and elements of the set of keywords can be a function of a meaningfulness parameter, which may operate as a threshold for meaningfulness of the keywords included in the set of keywords. “Meaningfulness” can be determined in according to various techniques, such as identification and ranking as defined by the Helmholtz principal (discussed below).

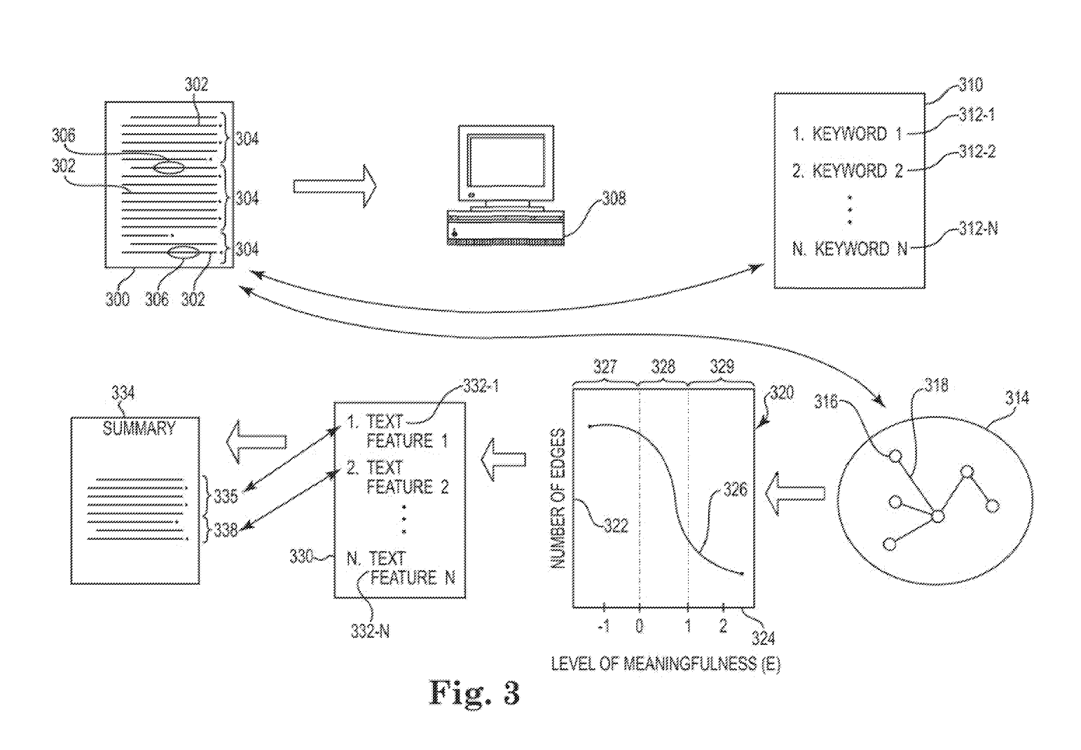

A document can be represented by a network, where nodes of the network correspond to text features of the document, and edges between particular nodes represent relationships between the text features represented by the particular nodes. Nodes representing adjacent text features in the document can be pined by an edge, as is shown in FIG. 1. Furthermore, nodes representing text features that include at least one keyword included in the identified set of keywords can also be joined by an edge, such as is shown below with respect to FIG. 2.

Representing a document as a network according to the present disclosure, can be distinguished from previous approaches, which may let nodes represent terms such as words or phrases (rather than text features such as sentences or larger), and may let edges merely represent co-occurrence of terms or weighting factors based upon mutual information between terms, which may not account for proximity or other relationship aspects that can convey information between text features larger than words/phrases. More specifically, for a previous approach network having nodes representing words occurring in a document, one node represents a word that can appear in many instances across the document. Such a representation may not capture the connectivity of information of the text features (e.g., sentences, paragraphs) across the many instances of the word represented by a same node.

A network according to the present disclosure however, can capture these relationships between sentences and paragraphs, based on proximity and keyword occurrence, since sentences and paragraphs (and other text features) are typically unique. Thus, a node in a network according to the present disclosure typically represents a singular occurrence in a document (e.g., of a sentence, paragraph) rather than multiple occurrences of words, and can result in liner tuning of the text feature relationships within the document. Furthermore, the methods of the present disclosure provides a mechanism for ranking nodes of the network representing the document, and thus for ranking the corresponding text features.

The graph of the network can also include attributes of the nodes (e.g., 132, 134) and/or edges 136 therebetween conveying certain information regarding the characteristics of the respective text feature or relationship(s). For example, node size can be used to indicate text feature size such as the number of words in a paragraph. The edge length can be used to indicate some information about the relationship between the connected text feature, such as whether the adjacent text features are successive paragraphs within a chapter, or successive paragraphs that end one chapter and begin a next chapter.

FIG. 2 illustrates a graph that may be formed based on another value of a meaningfulness parameter according to various examples of the present disclosure. At one extreme, every node can be connected to every other node in a network of relationships between the text features, which can correspond to a very low threshold for determining some relationship exists between each node representing a text feature. The graph 240 shown in FIG. 2 represents an intermediate scenario between the simple path graph shown in FIG. 1 and the extreme condition of almost every node being connected to almost every other node.

As shown in FIG. 2, nodes (e.g., 242, 244) representing text features are shown around a periphery, with edges 246 connecting certain nodes. Although not readily visible due to the scale of the graph, the node around a periphery can be connected to adjacent nodes similar to that shown in FIG. 1, representative of physical proximity of text features in a document. The nodes representing the first and last appealing text features in a document may not be interconnected in FIG. 2. The graph shown in FIG. 2 can include some nodes (e.g., 242) that are not connected to non-adjacent nodes, and some nodes (e.g., 244) that are connected to non-adjacent nodes.

The quantity of edges in the relationship network shown in the graph can change as a value of a meaningfulness parameter varies, where the meaningfulness parameter is a threshold for determining whether a relationship exists between pairs of nodes. That is, an edge can be defined to exist when a relationship between nodes representing text features is determined relative to the meaningfulness parameter. For example, the graph 240 shown in FIG. 2 can display those relationships that meet or exceed the threshold based on the meaningfulness parameter. Therefore, the appearance of the graph 240 can change as the meaningfulness parameter varies.

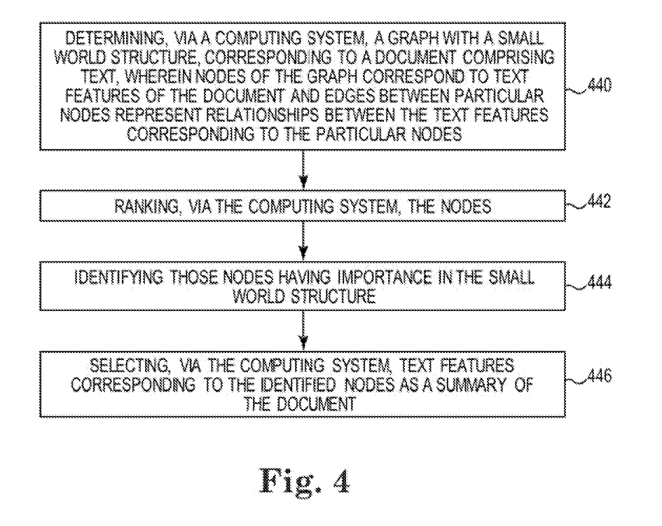

The text summarization methodology of the present disclosure does not require the graph to be plotted and/or visually displayed. The graph can be formed or represented mathematically without plotting and/or display, such as by data stored in a memory, and attributes of the graph determined by computational techniques other than by visual inspection. The consequence of the meaningfulness parameter on the structure of the network relationships of a document is discussed in more detail with respect to FIGS. 4A and 4B below.

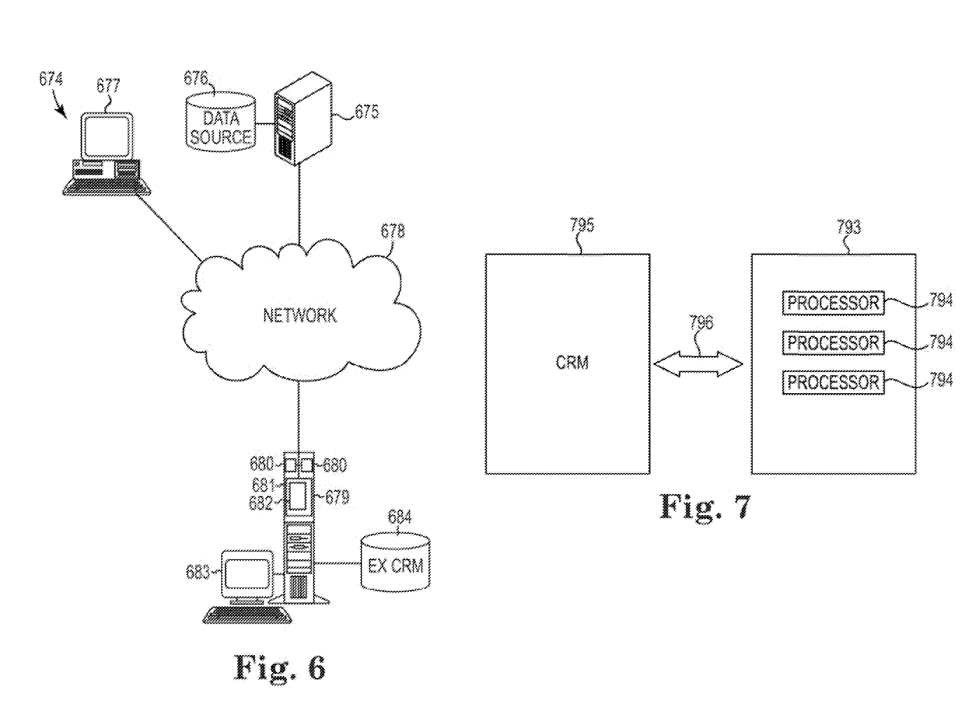

FIG. 3 conceptually illustrates one example of a method for text summarization according to various examples of the present disclosure. FIG. 3 shows a text summarization system 308 for implementing graph-based natural language text processing. The text summarization system 308 can be a computing system such as described further with respect to FIG. 6. The text summarization system 308 can access a document (e.g., natural language text, or collection of texts) 300 that includes a plurality of text features. In various alternative examples, the natural language text or collection of texts 300 may be in any desirable format including, but not limited to, formats associated with known word processing programs, markup languages, and the like. Furthermore, the texts 300 can be in any language or combination of languages.

As will be discussed in detail below, the text summarization system 308 can identify and/or select keywords (e.g., 312-1, 312-2, . . . , 312-N) and/or text features from the text 300. These can be organized into list(s) 310. The text summarization system 308 can also determine various connecting relationships between the text features, and the network of relationships formed by the nodes and edges, which can be based on a value of a meaningfulness parameter (e.g., used as a threshold for characterization of relationships). The graph 314 includes graph nodes 316 associated with the text features and graph edges 318 associated with the connecting relationships.

As previously discussed, the text features may include any desirable type of text features including, but not limited to, sentences 302, paragraphs 304, sections, pages, chapters, other language structures that include more than one sentence, and combinations thereof.

The text summarization system 308 can further determine (e.g., form, compute, draw, represent, etc.) a parametric family of graphs 314 (such as those shown and described with respect to FIGS. 1 and 2) for the network of relationships, including those relationship networks that have a small world structure. Such a small world structure can occur in many biological, social, and man-made systems, and other applications of networks. The text summarization system 308 can also determine, from the determined a graph 314, corresponding value(s) or ranges of values, of a meaningfulness parameter for which the graph(s) exhibit certain structural characteristics (e.g., small world structure).

That is, the text summarization system 308 can analyze the graph 314 for small world structure, such as by analyzing certain characteristics of the graph 314. One such analysis can be the relationship between a number of edges and the meaningfulness parameter, as shown in FIG. 3 by chart 320. Chart 320 plots a graph 326 of the number of edges 322 versus a level of meaningfulness parameter (ε) 324. As an example of possible behavior for a document, the meaningfulness parameter (ε) 324 can vary from negative values to positive values.

Chart 320 shows a curve 326 of number of edges 322 as a function of the meaningfulness parameter (ε) 324. Chart 320 is representative of a parametric family of graphs that can correspond to a structure of a document. For example, chart 320 can be at least one graph, of the parametric family of graphs, with a small world structure. The curve 326 has first portion 326 that is a relative flat (e.g., small slope) for negative values of the meaningfulness parameter (ε) 324, and a second portion 329 for positive values of the meaningfulness parameter (ε) 324 greater than 1. The curve 326 also includes a third portion, between the first 327 and second 329 portions, for values of the meaningfulness parameter (ε) 324 approximately between 0 and 1, the curve 326 becomes steep, and can include an infection point. The range of curve 326 after the third portion (e.g., second portion 329), for values for the meaningfulness parameter (ε) 324 for which curve 326 includes a steep portion can be associated with the network of relationships having a small world structure.

In mathematics, physics and sociology a small-world network can be a type of mathematical graph in which most nodes are not neighbors of one another, but most nodes can be reached from every other by a small number of hops or steps. More specifically, a small-world network can be defined to be a network where the typical distance L between two randomly chosen nodes (the number of steps) grows proportionally to the logarithm of the number of nodes N in the network, that it L ∝ Log(N). The idea of a small average length of edges accompanied by high clustering was first introduced in the classical Watts-Strogatz model, which was further refined in models by Newman and Kleinberg.

The small world structure (e.g., topology) can be expected to appear after the sharp drop in the number of edges in functions of the number of edges 322 as a function of the meaningfulness parameter (ε) 324, as can be observed from a graph thereof. This is because there is of the order of N² edges in a complete graph (i.e., every node connected to every other node), while the number of edges of a network having a small world structure is of the order of N logN. However, it should be noted that it is not sufficient if edges are randomly removed—the small world structure will not appear.

The behavior of the smell world structure relative to the N logN behavior usually anticipated may be a signature for the category/classification of the text itself. Therefore, small world behavior (e.g., structure, topology) can be tested to see if the text its a certain category. For example, more learned text (e.g., more extensive vocabulary) may be greater than N logN and less learned text (e.g., pulp fiction) may be less than N logN, etc.

In the context of a social network, this can result in the small world phenomenon of strangers being linked by a mutual acquaintance. In the context of text summarization, and the graph of network relationships between nodes representing text features and edges representing relationships above a threshold between the text features, a small world structure can represent text features being linked to other text features by a relationship of a defined strength.

The results of analyzing the graph 314 may be represented as a chart, such as 320, or as a list or table quantifying the relationship between the meaningfulness parameter (ε) 324 and the number of edges 322. Other attributes of graph 314 may also be analyzed with respect to text features and relationships between text features, graphically, mathematically, and/or logically. As used herein, the phrase “analyzing the graph” can refer to techniques for determining appropriate indicators of a small world structure, with or without actually graphing particular functions (e.g., functions can be analyzed mathematically).

From chart 320 (e.g., at least one of a parametric family of graphs that can correspond to a structure of a document), text features of the network having a small world structure can be ranked, as is shown in FIG. 3 by the ranking 330 of text features (e.g., 332-1, . . . , 332-N). Ranging may be summarized in a list, table, etc. However, examples of the present disclosure are not limited to physically collecting the text features into a summary, and text feature ranking can be accomplished by other methods such as by including a rank value associated with the text feature, among others.

As further shown in FIG. 3, a summary 334 of the original document 300 can be provided comprising N highest ranked text features. A first text feature of the summary 334 may be the highest ranked text feature 335, such as may be extracted from the original document 300 as indicated in FIG. 3. A second text feature of the summary 334 may be the next highest ranked text feature 338, and so on for additional text features, such as may be extracted from the original document 300 as also indicated in FIG. 3. While N text features are shown in example associated with ranking 330, and N highest ranked text features may be used to construct summary 334, examples of the present disclosure are not limited to all of the ranked text features (e.g., 332-1, . . . , 332-M) being used to create the summary 334. That is, a summary 334 may comprise fewer than all N ranked text features (e.g., 332-1, . . . , 332-N). For example, a user may specify some indication of summary length, such as a summary length (e.g., in pages, quantity of text features, etc.) to be included (e.g., from 0 to N text features). Such indication can be relative, such as specifying a summary be 10% of the original document length.

FIG. 4 illustrates an example method for text summarization according to various examples of the present disclosure. The example method of text summarizing includes determining, via a computing system, a graph with a small world structure, corresponding to a document comprising text, wherein nodes of the graph correspond to text features of the document and edges between particular nodes represent relationships between the text features represented by the particular nodes as indicated at 440. As shown at 442, the nodes are ranked via the computing system. Those nodes having importance in the small world structure are identified via the computing system, as illustrated at 444. As shown at 446, text features corresponding to the identified nodes are selected, via the computing system, as a summary of the document.

As was previously discussed, a document, and its structure, can be represented (e.g., modeled) by graphs (e.g., networks) G=(V, E) with text features such as sentences and/or paragraphs as the vertex set V. In network theory, a vertex is often referred to as a node. The edge between two nodes is used to represent the relationships between a pair of text features.

One task is to define relationships between text features in a document, which contains text, that result in graphs with similar properties and topology. More precisely, a relation between text features can be defined which produce graphs with a small world structure. Since documents are frequently generated by humans, and are generally intended for human consideration, it is natural to expect that during writing, an author will present his main ideas and concepts in a manner similar to biological networks.

One example approach to defining relations between text features can be summarized as follows:

1. Construct a parametric family of meaningful words MeaningfulSet(ε) for a document. For example, the parametric family of meaningful words (i.e., keywords) can involve one parameter. However, examples of the present disclosure are not so limited, and the parametric family can involve more than one parameter. The resulting sets can be compared to societies used for constructing corresponding affiliation networks. The parametric family of meaningful words MeaningfulSet(ε) for a document can be selected based on the Helmholtz principle, for example.

2. Connect two nodes (e.g., representing corresponding text features) by the edge if the corresponding text features have at least one word from the MeaningfulSet(ε) in common, or if the text features are a pair of consecutive text features. According to some examples, if the text features are not consecutive or do not each have at least one word from the MeaningfulSet(ε) in common, no edge connects the nodes. However, examples of the present disclosure are not to limited, and other criteria can be used in addition to, or in lieu of, the above-mentioned attributes to determine whether node pairs are connected.

3. Determine that for the keywords selected in the MeaningfulSet(ε) using Helmholtz's principle such graphs can have a small world structure (i.e., become a small world) for some range of the parameter ε. For most documents the range around ε=2 (e.g., greater than 1) can produce the desired small world structure.

If a set of keywords MeaningfulSet(ε) is too small, then the local relationships (e.g., proximity such as consecutive text features) may be present and the graph may look like a regular graph. If, however, too many keywords are selected, the graph can be a large random graph with too many edges.

To illustrate with several data sets, consider the size of “societies” for some text documents tested using the methods of the present disclosure. A relationship between a number of edges and a level of meaningfulness parameter can the plotted for documents analyzed according to various examples of the present disclosure, such as is shown in FIG. 3 at 320. Several documents were analyzed using the methods of the present disclosure including the 2011 State of the Union address given by President Barak Obama, the State of the Union address given by President Bill Clinton, and the Book of Genesis from the Natural Language Toolkit corpus. The text feature represented by nodes in a network relationship graph in each case was sentences. Therefore, edges represented relationships between sentences. The discussion that follows refers specifically to sentences as an example of a text feature, but examples of the present disclosure are not so limited and can be applied to other text features as previously defined.

Generally, when the meaningfulness parameter goes from a negative to a large positive value, a network relationship graph (e.g., as shown in FIG. 2) transforms from a large random graph to a regular graph. The transition into a small world structure (e.g., topology) can happen in between the extreme cases, such as just after the portion of the curve where the number of edges decreases significantly as was discussed with respect to graph 320 in FIG. 3 (e.g., the second portion of 329 of curve 326 for a range of meaningfulness perimeter greater than one). Having a small world topology is of interest in many ranking text features since in such graphs different nodes have different contributions to a graph being a small world.

One example approach of the present disclosure to the challenge of defining relationships between text features is as follows. A one-parameter family of meaningful words MeaningfulSet(ε) can be constructed for the document. That is, elements of the MeaningfulSet(ε) are keywords. Two text features can be connected by edge if they have at least one word from the MeaningfulSet(ε) in common. This type of network is common in the modeling of social networks as Affiliation Networks. The underlying idea behind affiliation networks is that in social networks there are two types of entitles: actors and societies. The entities can be related by affiliation of the actors to the societies. In an affiliation network, the actors are represented by the nodes. Two actors can be related if they both belong to at least one common society.

With respect to the experimental text summarization, the sentences can be the “actors” and each member of the MeaningfulSet(ε) can be a “society.” A sentence can “belong” to a word if this word appears in the sentence. The society MeaningfulSet(ε) can depend on the meaningfulness parameter ε. The family of graphs can become an affiliation network with a variable number of societies. A one-parameter family of graphs can have the same set of nodes but a different set of edges for different values of the meaningfulness parameter. If a set of meaningful words is too small, then the local relations (e.g., physical proximity of adjacent nodes) can be present and the graph will look like a regular graph. If, however, too many meaningful words are selected, then the graph can look like a large random graph with too many edges.

The size of the MeaningfulSet(ε) for the three experimental documents tested was determined as a function of ε. In all three experimental documents, the rapid drop of the size of the MeaningfulSet(ε) occurred within some vicinity of ε=0 (e.g., greater than 0). Many experiments were performed, which demonstrated that this type of behavior is typical for many real-world text documents with at feast thirty sentences. Such a rapid drop in the size of MeaningfulSet(ε) can happen for some positive ε and can be easily detected automatically with reference to the highest value of the derivative of the curve.

According to various examples of the present disclosure, the MeaningfulSet(ε) can be selected using the Helmholtz's principle such one parameter family of graphs becomes an interpolation between these two timing cases with a defined “phase transition” (e.g., for values of the meaningfulness parameter (ε) where the slope of a plot of the number of edges as a function of the meaningfulness parameter (ε) becomes steep). The graphs become a small world structure, and can have self-organized system, for some range of the meaningfulness parameter (ε) (e.g., greater than approximately one, greater than approximately two).

According to various examples of the present disclosure, when a graph topology becomes a small world structure, the most relevant nodes and edges of such a graph can be identified. That is, for a small world structure graph topology, the nodes and edges that contribute to the graph being a small world structure can be ascertained, which can provide a mechanism for determining the most relevant text features of a document. Since nodes can represent text features of a document according to the text summarization techniques of the present disclosure, identifying the most relevant nodes in a small world structure identifies most relevant text features in a document. Once identified, these relevant text features can be used for further document processing techniques. Such an approach can bring a belter understanding of complex logical structures and flows in text documents.

Some previous approaches of text data mining used the concept of a small world from social networking for keyword extraction in documents. Co-occurrence graphs are constructed by selecting words as nodes, and edges are introduced between two words based on the appearance of the two words in a same sentence. In contrast, various examples of the present disclosure utilize graphs built with text features that are other than single words as the nodes. The set of edges depends on the meaningfulness parameter (ε), which reflects a level of meaningfulness of the relationship between the text features, thus forming a one-parameter family of graphs.

A more rigorous discussion of example graphs of network relationships ascertained from document analysis follows. Let D denote a text document and P denote a text feature portion of text document D. P can be a paragraph of the text document D, for example, where the document is divided into paragraphs. P can alternatively be several consecutive sentences, for example, where the document is not divided into paragraphs.

Based on the Helmholtz Principle from the Gestalt Theory of human perception, a measure of meaningfulness of a word w from D inside P can be defined. If the word w appears m times in P and K times in the whole document D, then the number of false alarms NFA(ω, P, D) can be defined by the following expression:

$$( \begin{matrix}K \\ m\end{matrix} ) \cdot \frac{1}{{N}^{m - 1}} \qquad ( 1 )$$

where

$$( \begin{matrix}K \\ m\end{matrix} ) = \frac{K !}{m ! ( K - m ) !}$$

is a binomial coefficient. In equation (1) the number N is floor(L=B) where L is the length of the document D, and B is the length of P in words. The following expression is a measure of meaningfulness of the word w in P:

$$Meaning ( w , P , D ) := - \frac{1}{m} log NFA ( w , P , D ) . \qquad ( 2 )$$

The justification for using Meaning(w, P, D) is based on arguments from statistical physics.

A set of meaningful words in P is defined as words with Meaning(w, P, D)>0 and larger positive values of Meaning(w, P, D) give larger levels of meaningfulness. For example, given a document subdivided into paragraphs, MeaningfulSet(ε) can be defined as a set of all words with Meaning(w, P, D)>ε for at least one paragraph P. In general, paragraphs need not be disjoint. If a document does not have a natural subdivision into paragraphs, then several consecutive sentences (e.g., four or five consecutive sentences) can be used as the text feature (e.g., paragraph).

For a sufficiently large positive ε, the set MeaningfulSet(ε) may be empty. For ε<<0 the set MeaningfulSet(ε) can contain all the words from D. It has been observed for test documents that the size of MeaningfulSet(ε) can have a sharp drop from the total number of words in a document toward zero words around some reference value ε₀>0.

Since MeaningfulSet(ε) with a nonnegative ε is of interest in the approach of the present disclosure for automatic tot summarization, the MeaningfulSet(0) can be checked as being suitable for use in representing text in a natural language. Zipf's well-Known law for natural languages states that, given some corpus of documents, the frequency of any word can be inversely proportional to some power γ of is rank in fie frequency fable (i.e., frequency(rank)≈const/rank^{γ}), Zipf's law can be observed by plotting the data on a log-log graph, with the axes being log(rank order) and log(frequency). The data conforms to Zipf's law to the extent that the plot is linear. Usually, Zipf's law is valid for the upper portion of the log-log curve and not valid for the tail.

Zipf's law is a possible outcome of an evolving communicative system under a tension between two communicative agents. The speaker's economy tries to reduce the size of the dictionary, whereas the listener's economy tries to increase the size of the dictionary. This means that the MeaningfulSet(0) for the methods of the present disclosure should also obey Zipf's law in order to property represent topics and text. Using Zipf's law for the meaningful words of the corpus (ε=0) of the experimental documents, Zipf's law was observed to be satisfied, although the curve can be smoother and the power becomes smaller. If the level of meaningfulness is increased (i.e., larger ε), then the curve can become even smoother and more closely conforms to Zipf's law with smaller and smaller γ. This is as expected for good feature extraction and dimensionality reduction. That is, the number of features is decreased and the data is decorrelated. Similar results can be observed for many different documents and collections. Therefore, MeaningfulSet(ε) can be extremely powerful for document classifications.

According to various examples, additional and/or different keywords can be included in MeaningfulSet(ε). For example, if an original text document has its own set of keywords, such as title words, or keywords listed to aid a search engine, etc., then such keywords can also be added to the set MeaningfulSet(ε).

A one parameter family of graphs Gr(D, ε) can be defined for a document D. Document D can be pre-processed, for example, by splitting the words by non-alphabetic characters and down-casing all words. Stemming can be applied, for example, thereafter. Let S₁, S₂, . . . , Sₙ denote the sequence of consecutive text features (e.g., sentences) in the document D. For the discussion that follows, sentences are used to illustrate the method.

The graph Gr(D, ε) can have sentences S₁, S₂, . . . , Sₙ its vertex set. Since the order of text features (e.g., sentences) is relevant in documents, and since the nearest sentences are usually related, an edge can be added for every pair of consecutive sentences (Sᵢ, Sᵢ₊₁). This also assists connectivity of the graph to avoid unnecessary complications that can be associated with several connected components. Finally, if two sentences share at least one word from the set MeaningfulSet(ε) they too can be connected by an edge. In this manner, the family of graphs Gr(D, ε) can be defined, for example.

For a sufficiently large positive number ε, MeaningfulSet(ε)=0, and thus, Gr(D, ε) is the path graph (e.g., example of a path graph is illustrated in FIG. 1). As ε decreases, the MeaningfulSet(ε) increases in size. More and more edges can be added to the graph until the graph Gr(D, ε) can look like a random graph with a large number of edges. As preciously mentioned, the path graph and the large random graph are two extreme cases, neither of which reveals desired text summarization information. Of more interest is what happens between these two extreme scenarios.

There is a range of the parameter ε where Gr(D, ε) becomes a small world structure. That is, for some range of the parameter ε there can be a large change (e.g., drop) in the intercede distances after adding a relatively small number of edges.

Different clustering measures for Gr(D, ε) can also be utilized. With respect to complex architectures, hubs (i.e., strongly connected nodes) serve a pivotal role for ranking and classifications of nodes representing text features for analysis of documents. Graphs with a small world structure are usual in social networks, where there are a lot of local connections with a few long range ones. What makes such graphs informative is that a small number of long-range short-cuts make the resulting graphs much more compact than the original regular graphs with local connections. The Gr(D, ε) models of the present disclosure are much closer to the Newman and Kleinberg models than to the Watts-Strogatz one.

Experimental results for numerical experiments on the three different text documents are as indicated. As discussed generally above, the documents can be pre-processed, including splitting the words by non-alphabetic characters, making all words in lower case, and applying stemming, for example. With respect to the three test documents, natural paragraphs were used as a text feature for the two State of the Union documents, and a text feature (e.g., paragraph) was defined as any four nearest sentences for the Book of Genesis document.

For the three indicated text documents, the numbers of sentences, paragraphs, words and different words are presented in Table I.

TABLE I
DOCUMENT STATISTICS

| | | | | Different |
|---|---|---|---|---|
| Document | Sentences | Paragraphs | Words | Words |
| Obama, 2011 | 435 | 95 | 7083 | 1372 |
| Clinton, 2000 | 533 | 133 | 8861 | 1522 |
| Book of | 2343 | N/A | 35250 | 1975 |
| Genesis | | | | |

To better understand the properties of networks Gr(D, ε), different measures and metrics were examined. First of all, the number of edges in Gr(D, ε) were plotted for each of the three documents as a function of ε. There is a dramatic change (e.g., drop) in the number of edges in Gr(D, ε) for some ranges of positive values of ε. These are areas where small world structures are expected to be observed for the graphs Gr(D, ε). To formalize the notion of a small world structure, Watts and Strogatz defined the clustering coefficient and the characteristic path length of a network. Let G=(V, E) be a simple, undirected and connected graph with the set of nodes V=(v₁, . . . , vₙ) and the set of edges E. Let Iᵢⱼ denote the geodesic distance between two different nodes vᵢ and vⱼ. The geodesic distance is the length of a shortest path-counted in number of edges in the path. The characteristic path length (or the mean inter-node distance), L, is defined as the average of Iᵢⱼ over all pairs of different nodes (I, j):

$$L = \frac{1}{n ( n - 1 )} {\sum }_{i = j} {l}_{ij} .$$

The graph Gr(D, ε) depends on the parameter ε, so the characteristic path length become function L(ε) of the parameter ε. L(ε) is also a non-decreasing function of ε. Characteristic path lengths can be plotted. The example values of the characteristic path length L(ε) is shown in Table II below:

TABLE II
SOME VALUES OF L(ε) FOR THE 3 TEST DOCUMENTS

| ε | Obama | Clinton | The Book of Genesis |
|---|---|---|---|
| −1.0 | 1.358748 | 1.319542 | 1.309066 |
| 0.0 | 1.622702 | 1.773237 | 1.527610 |
| 1.0 | 2.937931 | 2.861523 | 2.079833 |
| 1.5 | 5.514275 | 3.945697 | 2.580943 |
| 2.0 | 12.274517 | 12.715485 | 3.727103 |
| 2.5 | 22.471095 | 52.442205 | 7.280936 |
| 3.0 | 89.049007 | 113.237971 | 18.874327 |
| 3.5 | 144.854071 | 177.272814 | 96.873744 |
| 4.0 | 145.333333 | 178.000000 | 317.638370 |
| 4.5 | 145.333333 | 178.000000 | 779.802265 |

With respect to clustering properties of the parametric graph Gr(D, ε), clustering is a description of the interconnectedness of the nearest neighbors of a node in a graph. Clustering is a non-local characteristic of a node and goes one step further than the degree. Clustering can be used in the study of many social networks. There are two widely-used measures of clustering: clustering coefficient and transitivity. The clustering coefficient C(vᵢ ) of a node vᵢ is the probability that two nearest neighbors of vi are themselves nearest neighbors. In other words,

$$C ( {v}_{i} ) = \frac{number\_of \_pairs \_of \_neighbors \_of \_vi \_that \_are \_connected}{number\_of \_pairs \_of \_neighbors \_of \_vi}$$

where q is a number of nearest neighbors of vᵢ (degree of the vertex) with tᵢ connections between them. C(vᵢ) is always between 0 and 1. When all the nearest neighbors of a node vᵢ are interconnected, C(vᵢ)=1, and when there are no connections between the nearest neighbors, as in trees, C(vᵢ)=0. Most real-world networks have strong clustering. The clustering coefficient for mean clustering) for an entire network can be calculated as the mean of local clustering coefficients of all nodes:

$${C}_{ws} = \frac{1}{n} {\sum }_{{v}_{i} ∈ V} {c}_{{v}_{i}}$$

where n is the number of vertices in the network. In several example of C_{ws} for real-world networks, for the collaboration graph electors C_{ws}=0.79, for the electrical power grid of the western United State C_{ws}=0.08, and for the neural network of the nematode worm C. elegans C_{ws}=0.28.

In the range ε ∈ [1.0, 2.5] the network Gr(D, ε) is a small world structure in the case of 2000 State of the Union address given by President Bill Clinton and in the case of the 2011 State of the Union address given by President Barack Obama. Both documents have a small degree of separation, high mean clustering C_{ws}, and a relatively small number of edges. For the Book of Genesis, the range ε ∈ [2, 3] also produces a small world structure with even more striking values of the mean clustering C_{ws}. Historically, C_{ws} can be the first measure of clustering in the study of networks and can be characteristic used as an indication of the method of the present disclosure. Another measure of clustering, transitivity, can also be used.

The clustering coefficient and the transitivity are not equivalent. They can produce substantially different values for a given network. Many consider the transitivity to be a more reliable characteristic of a small world structure than the clustering coefficient. Transitivity is often an interesting and natural concept in social networks modeling.

In mathematics, a relation R is said to be transitive if aRb and bRc together imply aRc. In networks, there are many different relationships between pairs of nodes. The simplest relation is “connected by an edge.” If the “connected by an edge” relation was transitive if would mean that if a node u is connected to a node v, and v is connected to w, then u is also connected to w. For social networks this can mean that “the friend of my friend is also my friend.” Perfect transitivity can occur in networks where each connected component is a complete graph (i.e., all nodes are connected to ail other nodes). In general, the friend of my friend is not necessarily my friend.

However, intuitively, a high level of transitivity can be expected between people. In the case of text summarization graphs Gr(D, ε), the transitivity can mean that if a sentence Sᵢ describes something similar to a sentence Sⱼ, and Sᵢ is also similar to a sentence Sₖ, then Sᵢ and Sₖ probably may also have something in common. So, if is natural to expect a high level of transitivity in graph Gr(D, ε) for some range of parameter ε.

The level of transitivity can be quantified in graphs as follows. If u is connected to v and v is connected to w, then there is a path uvw of two edges in the graph. If u is also connected to w, the path is a triangle. If the transitivity of a network is defined as the faction of paths of length two in the network that are triangle, then:

$$C = \frac{( number\_of \_triangles ) \times 3}{( number\_of \_connected \_triples )}$$

where a “connected triple” means three nodes u, v and w with edges (u, v) and (v, w). The factor of three in the numerator arises because each triangle will be counted three times during counting all connected triples in the network.

Some typical values of transitivity for social networks are provided for context. For example, the network of film actor collaborations has been found to have C=0.20; a network a collaborations between biologists has C=0.09; a network of people who send email to other people in a large university has C=0.16. Results of calculation of the transitivity for the three one parameter family of graphs indicate that ε in the range ε ∈ [1.0, 2.5], the network Gr(D, ε) has high transitivity in the case of the 2000 State of the Union address given by President Bill Clinton and in the case of the 2011 State of the Union address given by President Barack Obama. For the Book of Genesis, ε in the range ε ∈ [2, 3], the transitivity is also quite high (i.e., greater than 0.6).

From the Table I, Gr(D, ε) has 435 nodes in the Obama 2011 address, 533 nodes in the Clinton 2000 address, and 2343 nodes in the case of the Book of Genesis. So, if is not easy to represent such graphs graphically. A much nicer picture can be produced for the graph with the text features being paragraphs as a node set. The paragraphs can be connected by the same example rule provided above: two paragraphs me connected if they have meaningful words in common.

According to various examples of the present disclosure, after finding the range of the parameter ε corresponding to a small number of edges, a small mean distance, and high clustering, an extractive summary can be defined as follows:

1. Select a measure of centrally for small world networks.

2. Check that for the corresponding range of the parameter ε this measure of centrality has a wide range of values and the heavy-tail distribution.

3. Select text features with the highest ranking as a summary (e.g., assembled in an order of ranking).

The quantities intended by a “small” number of edges, a “small” mean distance, and “high” clustering can be specified by respective applicable pre-defined thresholds for each, such as by a user input, by relative quantities with respect to the small world network, and/or by convention associated with social network theory.

For two connected text features, it can be determined which one appears first and which one appears second, according to their position in a document. However, this can make such a graph look like small WWW-type network, and PageRankType methods can be used to produce relevant rankings of nodes. Social networks have demonstrated that real-world networks can become denser over lime, and their diameters effectively become smaller over time. A time parameter t can also be introduced in the method of the present disclosure by considering various document portions (e.g., the first t sentences of a document).

According to some examples, highest ranking paths in the graph can be selected (e.g., as transitions between text features selected for the summary) if some coherence in the summary is desired. According to some examples, the Helmholtz principle(s) can be used for calculating the measure of an unusual behavior in text documents.

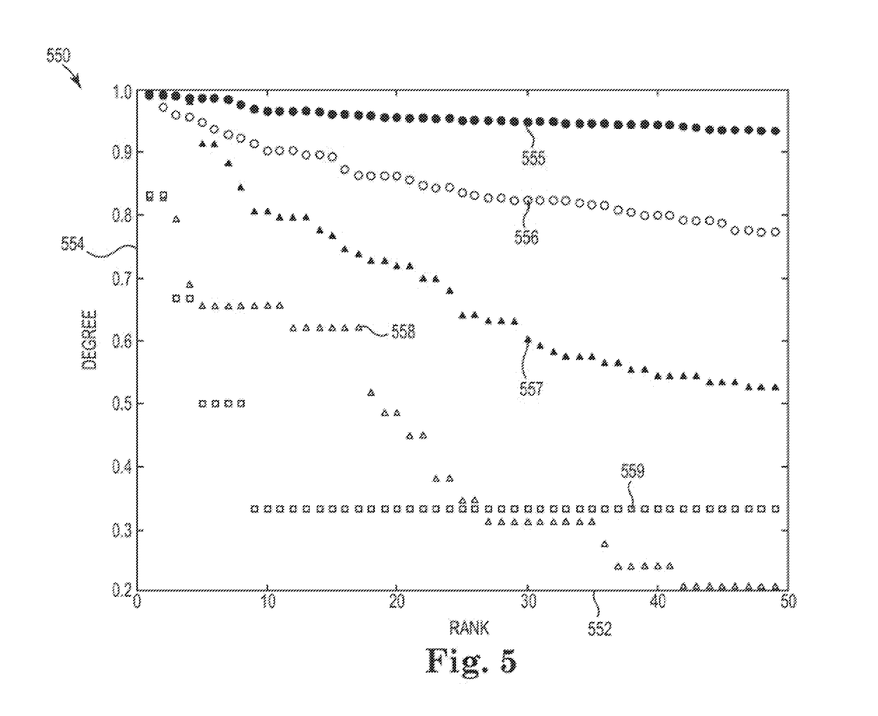

FIG. 5 illustrates a plot of degree-rank function for different values of a meaningfulness parameter according to various examples of the present disclosure. In the case of the 2011 State of the Union address given by President Barack Obama there are 95 paragraphs. For the value ε=2, several highly-connected nodes result in a small world structure. If nodes are ranked according to some ranking function, this function should provide a wide range of values. One ranking technique according to the present disclosure can involve ranking node according to their degree. In this manner, text features such as sentences can be ranked according to the text features degree. With respect to ranking of sentences according to their degree, all nodes in Gr(D, ε) can be sorted in decreasing order of degree to get a degree sequence d(ε)=(dₜ(ε), . . . , d₀(ε)), where d₁(ε)≧d₂(ε)≧ . . . ≧dₙ(ε). Consider, for example, the first fifty values of dᵢ in the case of the Obama speech. To have a reliable selection of five, ten, or more highest-ranked sentences, a wide range of values of the degree function are needed.

The term d(ε) can be plotted for several values of ε (e.g., first fifty elements) as the degree-rank function for different values of ε, as is shown in FIG. 5. FIG. 5 shows plots of degree as a function of rank for several values of ε, including ε=−1.0 at 555, ε=0.0 at 556, ε=1.0 at 557, ε=2.0 at 558, and ε=3.0 at 559. The degree values can be scaled such that the largest one, d₁(ε) can be set equal to one. The values ε=1.0 and ε=2.0 have the best dynamic range, and correspond to the graphs that have a small world structure. According to experimental results, the most connected sentence in the 2011 Obama address (for ε=2) is “The plan that has made all of this possible, from the tax cuts to the jobs, is the Recovery Act.” with a degree of 29.

The same technique can be applied to paragraph text features. For example, the two most relevant paragraphs in Obama address (for ε=2) according to the methods of the present disclosure can be extracted from a graph that uses paragraphs as nodes and the degree as measure of centrality: The first most relevant paragraph identified by the methods of the present disclosure is:

“The plan that has made all of this possible, from the tax cuts to the jobs, is the Recovery Act. That's right, the Recovery Act, also known as the stimulus bill. Economists on the left and the right say this bill has helped save jobs and avert disaster. But you don't have to take their word for it. Talk to the small business in Phoenix that will triple its workforce because of the Recovery Act. Talk to the window manufacturer in Philadelphia who said he used to be skeptical about the Recovery Act, until he had to add two more work shifts just because of the business it created. Talk to the single teacher raising two kids who was told by her principal in the last week of school that because of the Recovery Act, she would't be laid off after all.”

And the second most relevant paragraph identified by the methods of the present disclosure is:

“Now, the price of college tuition is just one of the burdens facing the middle class. That's why last year, I asked Vice President Biden to chair a task force on middle dam families. That's why we're nearly doubling the child care tax credit and making it easier to save for retirement by giving access to every worker a retirement account and expanding the tax credit for those who start a nest egg. That's why we∝re working to lift the value of a family's single largest investment, their home. The steps we took last year to shore up the housing market have allowed millions of Americans to take out new loans and save an average of $1,500 on mortgage payments. This year, we will step up refinancing so that homeowners can move into more affordable mortgages.”

The approach presented in this disclosure is suitable for large documents where complicated network structures can be observed. However, for short texts, such as news stories, the approach of the present disclosure may be less accurate depending on the proportions of the quantity of text comprising the summary to quantity of text comprising the original text. Generally, a greater quantity of original text from which to determine most relevant portions, which can be used in summarization, produce better results.

One challenge of automatic text summarization is its evaluation. Unfortunately, there is no universally accepted strategy and toolset for evaluating summaries. The challenge is that humans produce summaries with a wide variance and there is no agreement on what should be a “good” summary. However, different measures and metrics for complex networks, such as the eigenvector centrality, Katz centrality, hubs and authorities, betweenness centrality, power law and scale-free networks, can be used to evaluate text summarization effectiveness. These metrics and measures can be used to help quantify text summarization criteria, and in doing so can provide some objective measurement capability by which to evaluate automate text summarization.

Summaries created from such small world graphs can be checked to be very good for a large collection of different documents. Unfortunately, there is no generally-accepted standard for the evaluation of summaries. One tool currently used is the ROUGE (Recall-Oriented Understudy for Gisting Evaluation) metric, which can be used to evaluate the methodology of the present disclosure. Many previous approaches to automatic text summarization methods used several heuristics like the cue method, title method, and location method to evaluate a summary.

FIG. 6 illustrates a block diagram of an example computing system used to implement a text summarization system according to the present disclosure. The computing system 674 can be comprised of a number of computing resources communicatively coupled to the network 678. FIG. 6 shows a first computing device 675 that may also have an associated data source 676, and may have input/output devices (e.g., keyboard, electronic display). A second computing device 679 is also shown in FIG. 6 being communicatively coupled to the network 678, such that executable instructions may be communicated through the network between the first and second computing devices.

Second computing device 679 may include a processor 680 communicatively coupled to a non-transitory computer-readable medium 681. The non-transitory computer-readable medium 681 may be structured to store executable instructions 682 that can be executed by the processor 680 and/or data. The second computing device 679 may be further communicatively coupled to a production device 683 (e.g., electronic display, printer, etc.). Second computing device 679 can also be communicatively coupled to an external computer-readable memory 684.

The second computing device 679 can cause an output to the production device 683, for example, as a result of executing instructions of a program stored on non-transitory computer-readable medium 681, by the at least one processor 680, to implement a system for incremental image clustering according to the present disclosure. Causing an output can include, but as not limited to, displaying text and images to an electronic display and/or punting text and images to a tangible medium (e.g. paper). Executable instructions to implement incremental image clustering may be executed by the first 675 and/or second 679 computing device, stored in a database such as may be maintained in external computer-readable memory 684, output to production device 683, and/or printed to a tangible medium.

Additional computers 677 may also be communicatively coupled to the network 678 via a communication link that includes a wired and/or wireless portion. The computing system can be comprised of additional multiple interconnected computing devices, such as server devices and/or clients. Each computing device can include control circuitry such as a processor, a state machine, application specific integrated circuit (ASIC), controller, and/or similar machine.

The control circuitry can have a structure that provides a given functionality, and/or execute computer-readable instructions that are stored on a non-transitory computer-readable medium (e.g., 676, 681, and 684). The non-transitory computer-readable medium can be integral (e.g., 681), or communicatively coupled (e.g., 676, 684) to the respective computing device (e.g., 675, 679) in either a wired or wireless manner. For example, the non-transitory computer-readable medium can be an infernal memory, a portable memory, a portable disk, ore memory located internal to another computing resource (e.g., enabling the computer-readable instructions to be downloaded over the Internet). The non-transitory computer-readable medium (e.g., 676, 681, and 684) can have computer-readable instructions stored thereon that are executed by the control circuitry (e.g. processor) to provide a particular functionality.

The non-transitory computer-readable medium, as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, EEPROM, phase change random access memory (PCRAM), among others. The non-transitory computer-readable medium can include optical discs, digital video discs (DVD), Blu-ray discs, compact discs (CD), laser discs, and magnetic media such as tape drives, floppy discs, and hard drives, solid state media such as flash memory, EEPROM, phase change random access memory (PCRAM), as well as other types of machine-readable media.

Logic can be used to implement the method(s) of the present disclosure, in whole or part. Logic can be implemented using appropriately configured hardware and/or software (i.e., machine readable instructions). The above-mention logic portions may be discretely implemented and/or implemented in a common arrangement.

FIG. 7 illustrates a block diagram of an example computer readable medium (CRM) 795 in communication, e.g., via a communication path 796, with processing resources 793 according to the present disclosure. As used herein, processor resources 793 can include one or a plurality of processors 794 such as in a parallel processing arrangement. A computing device having processor resources can be in communication with, and/or receive a tangible non-transitory computer readable medium (CRM) 795 storing a set of computer readable instructions for capturing and/or replaying network traffic, as described herein.

The above specification, examples and data provide a description of the method and applications, and use of the system and method of the present disclosure. Since many examples can be made without departing from the spirit and scope of the system and method of the present disclosure, this specification merely sets forth some of the many possible example configurations and implementations.

Although specific examples have been illustrated and described herein, an arrangement calculated to achieve the same results can be substituted for the specific examples shown. This disclosure is intended to cover adaptations or variations of various examples provided herein. The above description has been made in an illustrative fashion, and not a restrictive one. Combination of the above examples, and other examples not specifically described herein will be apparent upon reviewing the above description. Therefore, the scope of various examples of the present disclosure should be determined based on the appended claims, along with the full range of equivalents that are entitled.

Throughout the specification and claims, the meanings identified below do not necessarily limit the terms, but merely provide illustrative examples for the terms. The meaning of “a,” “an,” and “the” includes plural reference, and the meaning of “in” includes “in” and “on.” “Embodiment,” as used herein, does not necessarily refer to the same embodiment, although it may.

In the foregoing discussion of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of this disclosure.

Some features are grouped together in a single embodiment for the purpose of streamlining the disclosure. This method of disclosure is not to be interpreted as reflecting an intention that the disclosed examples of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method for text summarization, comprising:
determining, via a computing system (674), a graph (314) with a small world structure, corresponding to a document (300) comprising text, wherein nodes (316) of the graph (314) correspond to text features (392, 304) of the document (300) and edges (318) between particular nodes (316) represent relationships between the text features (302, 304) represented by the particular nodes (316) (440);
ranking, via the computing system (674), the nodes (316) (442);
identifying, via the computing system (674), those nodes (316) having importance in the small world structure (444); and
selecting, via the computing system (674), text features (302, 304) corresponding to the identified nodes (316) as a summary (334) of the document (300) (446).

2. The method of claim 1, wherein determining a graph (314) with a small world structure includes:
determining, via a computing system (674), a parametric family of graphs (314) corresponding to a structure of the document (300) comprising text (440);
varying, via the computing system (674), a parameter of the parametric family of graphs (314);
identifying, via the computing system (674), at least one graph (314) with a small world structure; and
joining nodes (316) representing adjacent text features (302, 304) in the document (300) by an edge (318) and nodes (316) representing text features (302, 304) that include at least one keyword (312-1, 312-2, . . . , 312-N) included in an identified set of keywords (312-1, 312-2, . . . , 312-N) by an edge (318).

3. The method of claim 2, wherein the text features (302, 304) are language structures larger than a paragraph (304)

4. The method of claim 2, wherein ranking the nodes (310) includes ranking the nodes (316) based on the quantity of edges (318) associated with the respective nodes (316), the set of Keywords (312-1, 312-2, . . . , 312-N) being selected using a Helmholtz principle.

5. The method of claim 1, wherein selecting text features as the summary (334) includes:
extracting a number of top ranked text features (302, 304) from the document (300); and
assembling the number of top ranked text features (302, 304) in the summary (334) according to the ranking of the corresponding node (316).

6. The method of claim 1, wherein selecting text features as the summary (334) includes selecting a highest ranking path in the at least one graph (314) with the small world structure as transitions between the selected text features (302, 304).

7. The method of claim 1, wherein providing the summary (334) includes:
receiving input specifying summery (334) length; and
determining a quantify of text features (302, 304) to be selected for the summary (334) based on the received input specifying summary (334) length.

8. The method of claim 7, wherein receiving input specifying summary (334) length includes receiving a percentage of the text features (302, 304) comprising the document (300).

9. The method of claim 7, wherein receiving input specifying summary length includes receiving a quantity of text features (302, 304) to include in the summary (334).

10. The method of claim 1, further comprising:
determining a range of a parameter for which the graph (314) has a small world structure (444) with a small number of edges, a small mean inter-node distance, and high clustering;
selecting a measure of centrality for small world networks; and
checking for a corresponding range of the parameter that the measure of centrality has a wide range of values and a heavy-tail distribution.

11. The method of claim 19, wherein ranking the nodes (316) includes sorting the nodes (318) in a decreasing order of the measure of centrality in the small world.

12. A non-transitory computer-readable medium (676, 681,684, 795) having computer-readable instructions (682) stored thereon that, if executed by a processor (680, 784), cause the processor (680, 794) to:
determine a one-parameter family of graphs (314) corresponding to a structure of a document (300) comprising text;
vary a parameter of the one-parameter family of graphs (314);
identify at least one graph (314) with a small world structure;
rank the text features (302, 304) corresponding to the at least one graph (314) with the small world structure; and
provide a summary (334) of the document (300) comprising a number of top ranked text features (302, 304),
wherein the parameter is a meaningfulness parameter (324).

13. The non-transitory computer-readable medium (676, 681, 684, 795) of claim 12, further having computer-readable instructions (682) stored thereon that, if executed by the processor (680, 794), cause the processor (680, 794) to:
identify a set of keywords (312-1, 312-2, . . . , 312-N) of the document (300) as a function of a meaningfulness parameter (324);
represent a graph, wherein nodes (316) of the graph (314) correspond to text features (302, 304) of the document (300) and edges (318) between particular nodes (316) represent relationships between the text features (302, 304) represented by the particular nodes (316); and
join nodes (316) representing adjacent text features (302, 304) in the document (300) by an edge (318) and nodes (316) representing text features (302, 304) that include at least one keyword (312-1, 312-2, . . . , 312-N) included in the identified set of keywords (312-1, 312-2, . . . , 312-N) by an edge (318),
wherein the meaningfulness parameter (324) is a Helmholtz meaningfulness parameter.

14. A computing system (674), comprising:
a non-transitory computer-readable medium (676, 681, 684, 795) having computer-readable instructions (682) stored thereon; and
a processor (680, 794) coupled to the non-transitory computer-readable medium (676, 681, 684, 795), wherein the processor (680, 794) executes the computer-readable instructions (682) to:
determine a one-parameter family of graphs (314) corresponding to a structure of a document (300) comprising text;
vary a parameter of the one-parameter family of graphs (314);
identify at least one graph (314) with a small world structure;
rank the text features (302, 304) corresponding to the at least one graph (314) with the small world structure; and
provide a summary (334) of the document (300) comprising a number of top ranked text features (302, 304),
wherein the parameter is a Helmholtz meaningfulness parameter (324).

15. The computing system (674) of claim 14, wherein the processor executes the computer-readable instructions to:
receive as user input a quantity of text features (302, 304) to include in the summary (334);
extract the number of top ranked text features (302, 304) from the document (300); and
assemble the number of top ranked text features (302, 304) in the summary (334) according to their respective ranking and the number being based on the received quantity of text features (302, 304).
